(19) United States
(12) Patent Application Publication
(10) Pub. No.: US 2008/0173380 A1
(43) Pub. Date: Jul. 24, 2008

(54) PNEUMATIC TIRE

(75) Inventor: Masaaki Ohara, Osaka-fu (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka-fu (JP)

(21) Appl. No.: 11/956,528

(22) Filed: Dec. 14, 2007

(30) Foreign Application Priority Data
Jan. 19, 2007 (JP) 2007-09777

(51) Int. Cl. B60C 11/01

(52) U.S. Cl. 152/209.16

(57) ABSTRACT

The pneumatic tire has the characteristics in that the pneumatic tire is provided with a plurality of main grooves 1 extending in the tire circumferential direction formed on a tread T, a rib 2 formed at least on the shoulder portion of the tread T, a first fine groove 3 extending in the tire circumferential direction formed on the inner side of the tire width direction than a grounding end E, and the thin rib 4 formed by the first fine groove 3 and the grounding end E, wherein a second fine groove 5 is formed on the outer side of the tire width direction than the grounding end E, the second fine groove 5 is on the outer side of the tire width direction than a virtual surface S1 that passes the grounding end E and is vertical to the tire rotational axis.

The description of this application claims benefit of priority based on Japanese Patent Application No. 2007-9777, the entire same contents of which are incorporated by reference herein.

### BACKGROUND OF THE INVENTION

1. Field of the Invention

The present invention relates to a pneumatic tire, and in more detail, the present invention relates to the pneumatic tire provided with thin ribs in the vicinity of a grounding end, with inhibited uneven wear at a shoulder portion of a tread.

2. Description of the Prior Art

In pneumatic tires, since grounding pressure at a shoulder portion of a tread gets higher, there used to arise a problem of uneven wear in which the wear amount at the shoulder portion is greater than at the other portions. In order to inhibit such uneven wear, as shown in FIG. 1, a fine groove 3 is formed that extends in the tire circumferential direction from a grounding end E to the inner side in the tire width direction, and a thin rib 4 sandwiched by the fine groove 3 and the grounding end E is provided. As a result, rigidity at the shoulder portion of the tread T is degraded by the thin rib 4, and the grounding pressure at the shoulder portion gets lower, thereby capable of inhibiting the uneven wear. As one example of such pneumatic tires, the one disclosed in Patent Document 1 is known (Patent document 1: Unexamined Japanese Laid-Open Patent Publication No. 11-151910, FIG. 4).

In the above mentioned pneumatic tire, the thin rib 4 is liable to deformation caused by force from a road surface. When the tire roles on a stepped road G as shown in FIG. 2, the fine groove 3 opens wide by the step, and when deformed extremely, cracks are generated at a bottom 3a of the fine groove 3, which sometimes degrades durability of the tire. It can also be considered to narrow the width of the thin rib 4 in order to inhibit generation of cracks. However, to do so might make the inhibition effect of the uneven wear unsatisfactory, which sometimes leads the thin rib 4 to break. And when the thin rib 4 disappears, the inhibition effect of the uneven wear disappears, too.

Therefore, the object of the present invention is to effectively inhibit the uneven wear and to enhance the durability of the shoulder portion.

### SUMMARY OF THE INVENTION

In order to solve the above mentioned problem, the present invention has characteristics in that it relates to a pneumatic tire provided with a plurality of main grooves formed that extend in the tire circumferential direction on a tread, with ribs formed at least on a shoulder portion of the tread, a first fine groove formed that extends in the tire circumferential direction on the inner side in the tire width direction than the grounding end, and a thin rib formed by the first fine groove and by the grounding end, wherein a second fine groove is formed on the outer side in the tire width direction than the grounding end, the second fine groove is on the outer side in the tire width direction than a virtual surface that passes the grounding end and is vertical to the tire rotational axis.

By forming the first fine groove that extends in the tire circumferential direction on the inner side of the tire width direction than the grounding end, the rigidity at the shoulder portion is degraded and the grounding pressure is also lowered, thereby inhibiting the uneven wear. By the second groove, a narrowed portion is formed on a cross-sectional view in the width direction on the thin rib. When the tire rolls on the stepped road surface, the narrowed portion is bent, which inhibits the opening of the first fine groove. As a result, stress applied to the bottom of the first fine groove can be alleviated, thereby capable of inhibiting generation of cracks at the bottom of the first fine groove.

In addition, as the wear progresses, the crack at the bottom of the second fine groove does not cause any problem. However, when the bottom of the second fine groove is on the inner side of the tire width direction than a virtual surface that passes through the grounding end and is vertical to the tire rotational axis, the narrowed portion of the thin rib gets so narrow that it sometimes causes the problem of the crack at the bottom of the second fine groove.

The pneumatic tire of the present invention also relates to the pneumatic tire with a third fine groove extending in the tire circumferential direction further formed between the grounding end and the first fine groove.

By forming the third fine groove between the grounding end and the first fine groove, that is, by forming the third fine groove on the thin rib, and by dividing the thin rib, the opening of the first fine groove can further be inhibited. As a result, generation of cracks at the bottom of the first fine groove can further be inhibited.

The pneumatic tire of the present invention also relates to the pneumatic tire in which the distance from the bottom of the first fine groove to the second fine groove is 20% to 50% of the depth of the first fine groove.

The position of the second fine groove determines the position of the narrowed portion of the thin rib and affects the deformation of the thin rib. Therefore, it is preferable that the distance from the bottom of the first fine groove to the second fine groove (the distance projected on the tire equator surface) is 20% to 50% of the depth of the first fine groove. When this distance is less than 20% of the depth of the first fine groove, since the distance between the narrowed portion and the bottom of the first fine groove is near, the degree of the deformation of the thin rib gets greater, which even more makes the stress applied to the groove bottom large and causes generation of cracks more easily. On the other hand, when this distance is greater than 50% of the depth of the first fine groove, since the distance between the tread surface and the bottom of the first fine groove is large, the effect of alleviating the stress at the bottom of the first fine groove by the narrowed portion gets smaller.

### BRIEF DESCRIPTION OF THE DRAWINGS

FIG. 1 is an oblique perspective view showing the tread shoulder portion in the conventional pneumatic tire.

FIG. 2 is a cross-sectional view showing the grounding state on a stepped road surface in the conventional pneumatic tire.

FIG. 3 is an oblique perspective view showing the tread shoulder portion in the pneumatic tire of the present invention.

FIG. 4 is across-sectional view showing the grounding state on a stepped road surface in the pneumatic tire of the present invention.

FIG. 5 is an oblique perspective view showing the tread shoulder portion in the pneumatic tire of the present invention.

FIG. 6 is a cross-sectional view showing the grounding state on a stepped road surface in the pneumatic tire of the present invention.

### DESCRIPTION OF THE PREFERRED EMBODIMENTS

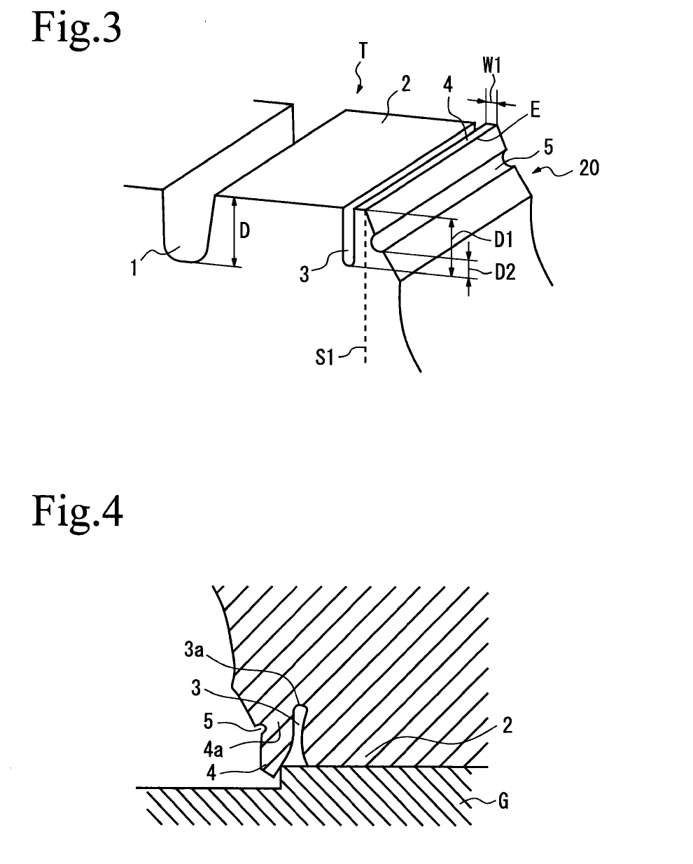

Hereinafter, explanation on embodiments for carrying out the pneumatic tire of the present invention is made using drawings. FIG. 3 is an oblique perspective view showing the shoulder portion of a tire tread. On a tread T, a main groove 1 extending in the tire circumferential direction R is formed. A rib 2 is formed on a shoulder portion by the illustrated outermost main groove 1 in the width direction and the grounding end E. Further, a first fine groove 3 extending in the circumferential direction is formed from the grounding end E to the inner side in the tire width direction, and a thin rib 4 is formed. Therefore, as already mentioned, since the rigidity of the shoulder portion of the tread T is degraded by the thin rib 4 and the grounding pressure at the shoulder portion is lowered, uneven wear at the shoulder portion is inhibited. For information, members such as belt layers, belt reinforcement layers, and the like are omitted in FIG. 3. In addition, ribs may be arranged in an inner region by the illustrated outermost main groove 1 in the width direction, and blocks may be arranged partially or entirely.

A second fine groove 5 is formed on a buttress portion 20 that is on the outer side in the tire width direction from the grounding end E, and a narrowed portion 4a is formed on the thin rib 4. When the tire rolls on the stepped road G as shown in FIG. 4, since the narrowed portion 4a is liable to deformation, the opening of the first fine groove 3 is inhibited and the stress applied to the groove bottom 3a is alleviated. As a result, generation of cracks at the groove bottom 3a can be inhibited.

It is preferable that when the tire is installed on a standard rim and filled with air at a standard inner pressure, the groove bottom of the second fine groove 5 is on the outer side in the tire width direction than the virtual surface S1 that passes the grounding end E and is vertical to the tire rotational axis. When the groove bottom of the second fine groove 5 is on the inner side in the tire width direction than a virtual surface S1, the narrowed portion 4a of the thin rib 4 gets so narrow that the problem sometimes occurs in regard of cracks at the groove bottom of the second fine groove 5.

The position of the second fine groove 5 determines the position of the narrowed portion 4a of the thin rib 4 and affects the deformation of the thin rib 4. Therefore, it is preferable that D2 that is the distance projected on the tire equator surface from the groove bottom of the first fine groove 3 to the second fine groove 5 is 20% to 50% of D1 that is the depth of the first fine groove 3. When this distance is less than 20% of the depth of the first fine groove 3, since the distance between the narrowed portion 4a and the bottom of the first fine groove 3 is near, the degree of the deformation of the thin rib 4 gets greater, which even more makes the stress applied to the groove bottom 3a large and causes generation of cracks more easily. On the other hand, when this distance is greater than 50% of the depth of the first fine groove, since the distance between the tread surface and the bottom 3a of the first fine groove is large, the effect of alleviating the stress at the bottom 3a of the first fine groove 3 by the narrowed portion 4a gets smaller.

From the view point of obtaining effective bend of the thin rib 4, it is preferable that the width of the second fine groove 5 is 2.0 mm to 5.0 mm and that the depth of the second fine groove 5 is 11.0 mm to 2.5 mm. In addition, the cross sectional shape of the second fine groove 5 may be semicircular or V-shaped other than U-shaped.

From the view point of effectively inhibiting uneven wear, it is preferable that the first fine groove 3 is formed so that W1 that is the width of the thin rib 4 is 11.0 mm to 10.0 mm. It is preferable that the width of the first fine groove 3 is 0.5 mm to 3.0 mm and that D1 that is the depth of the first fine groove 3 is 10.0 mm to 16.5 mm, or 70% to 110% of D that is the depth of the main groove 1.

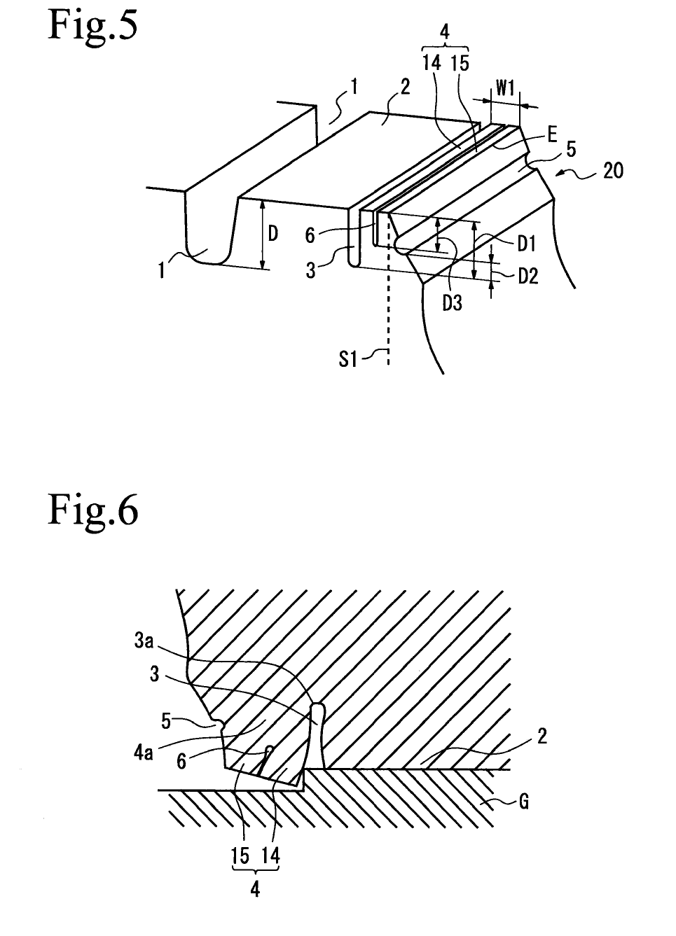

Next, other embodiments for carrying out the present invention are explained. FIG. 5 is another example in which the thin rib 4 is further divided into ribs 14 and 15 by a third fine groove 6. As shown in FIG. 6, when the tire rolls on the stepped road surface G, the narrowed portion 4a is liable to deformation and further, by the closure of the third fine groove 6, the opening of the first fine groove 3 is further inhibited and the stress applied to the groove bottom 3a is alleviated. As a result, generation of cracks at the groove bottom 3a can further be inhibited.

In this example, it is preferable that the width of the third fine groove 6 is 0.5 mm to 3.0 mm, that the depth D3 is 5.0 mm to 12.0 mm, or that the depth D3 is 50% to 70% of the depth D of the main groove 1. From the view point of effectively inhibiting the uneven wear, it is preferable to form the first fine groove 3 so that W1 that is the width of the thin rib 4 is 5.0 mm to 15.0 mm and by providing the third fine groove 6, W1 that is the width of the thin rib 4 can be widened. Also, it is preferable to provide the third groove 6 so that the ratio of the width of the thin rib 14 with respect to the width of the thin rib 15 is 0.6 to 2.5. When the ratio is out of this range, either of the widths of the thin ribs 14 and 15 gets narrower, and the satisfactory effect for inhibiting the uneven wear cannot be obtained. In addition, when D3 that is the depth of the third fine groove 6 is deeper than D1 that is the depth of the first fine groove 3, generation of cracks is liable to occur at the bottom of the third fine groove 6 and the effect of inhibiting uneven wear cannot be obtained by the third fine groove 6. Even when cracks are generated at the groove bottom, it is preferable to make the third fine groove 6 disappear by the wear in order to prevent its progress. Therefore, it is preferable that D1 that is the depth of the first fine groove 3 is deeper than D3 that is the depth of the third fine groove 6.

### EXAMPLE

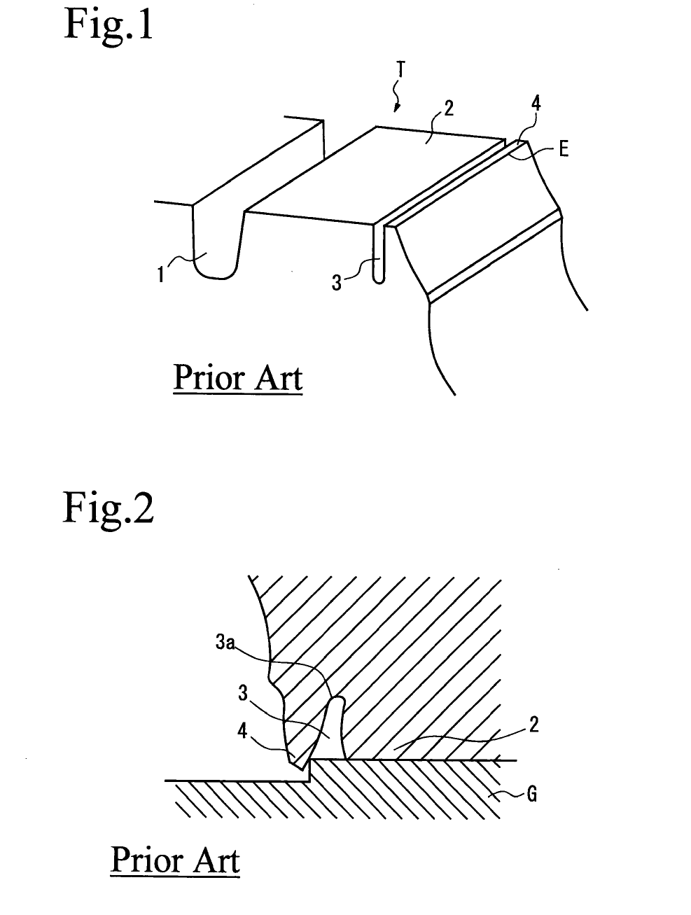

As Examples, the pneumatic tires of the present invention and those of the Comparative Examples were test produced and the evaluation was made by installing the tires on front wheels of a tractor for towing a trailer (axle arrangement 2D). For information, the tire size was 295/75R 22.5 and air pressure was 720 kPa. The tires of the Examples 1 and 2 are for the tires provided with the shoulder portions as shown in FIGS. 3 and 5, respectively, the tire of the Comparative Example 1 is for the tire provided with the shoulder portion as shown in FIG. 1, and the tire of the Comparative Example 2 is for the same tire as in the Example 1 except that the bottom of the second fine groove 5 is on the inner side in the tire width direction than the virtual surface S1.

The sizes of each of the fine grooves are shown in Table 1. When the distance from the bottom of the second fine groove to the virtual surface S1 is positive, it shows that the groove bottom is on the outer side in the tire width direction than the virtual surface S1, and when the distance from the bottom of the second fine groove to the virtual surface S1 is negative, it shows that the groove bottom is on the inner side in the tire width direction than the virtual surface S1.

The evaluation results are shown in Table 1. Uneven wear resistance performance is the value of the width of the local wear of the first fine groove side of the rib 2 after driving 160,000 km represented by an index, letting the value of the Comparative Example 1 represented as 100, and the larger value shows the narrower width of the local wear, showing that the effect of inhibiting the uneven wear is high. The presence of cracks at the groove bottoms are shown as a result by visually observing the tires after driving 160,000 km. The Table 1 showed that the cracks were generated at the bottom of the fine grooves in the Comparative Examples 1 and 2, and that the thin ribs were absent and fallen behind in the Comparative Example 2. On the other hand, it showed the improvement in durability and in the inhibition effect of uneven wear in the Examples 1 and 2.

TABLE 1

| | | | | Comparative | Comparative |
|---|---|---|---|---|---|
| | | Example 1 | Example 2 | Example 1 | Example 2 |
| Width of the first | | 2.0 | 2.0 | 2.0 | 2.0 |
| fine groove (mm) | | | | | |
| Depth of the first | | 15.5 | 15.5 | 15.5 | 15.5 |
| fine groove (mm) | | | | | |
| Width of the second | | 3.0 | 3.0 | — | 3.0 |
| fine groove (mm) | | | | | |
| Depth of the second | | 1.5 | 1.5 | — | 4.0 |
| fine groove (mm) | | | | | |
| Width of the third | | — | 0.5 | — | — |
| fine groove (mm) | | | | | |
| Depth of the third | | — | 8.0 | — | — |
| fine groove (mm) | | | | | |
| Width of the thin | | 2.5 | 8.5 | 2.5 | 2.5 |
| rib 4 (mm) | | | | | |
| Width of the thin | | — | 5.0 | — | — |
| rib 14 (mm) | | | | | |
| Width of the thin | | — | 3.0 | — | — |
| rib 15 (mm) | | | | | |
| Distance from the | | 1.7 | 1.7 | — | −1.5 |
| groove bottom of | | | | | |
| the second fine | | | | | |
| groove to the | | | | | |
| virtual surface | | | | | |
| S1 (mm) | | | | | |
| Uneven wear | | 105 | 145 | 100 | 103 |
| resistance | | | | | |
| performance | | | | | |
| Cracks at | The | No | No | Locally yes | Yes |
| the | first | | | | |
| groove | fine | | | | |
| bottom | groove | | | | |
| | The | — | No | — | — |
| | third | | | | |
| | fine | | | | |
| | groove | | | | |

Depth of the main groove: 15.1 mm

What is claimed is:

1. A pneumatic tire provided with a plurality of main grooves formed that extend in the tire circumferential direction on a tread, with ribs formed at least on a shoulder portion of the tread, a first fine groove formed that extends in the tire circumferential direction on the inner side in the tire width direction than the grounding end, and a thin rib formed by the first fine groove and by the grounding end, wherein a second fine groove is formed on the outer side in the tire width direction than the grounding end, the second fine groove is on the outer side in the tire width direction than a virtual surface that passes the grounding end and is vertical to a tire rotational axis.

2. The pneumatic tire as set forth in claim 1, wherein a third fine groove extending in the tire circumferential direction is further formed between the grounding end and the first fine groove.

3. The pneumatic tire as set forth in claim 1, wherein the distance from the bottom of the first fine groove to the second fine groove is 20% to 50% of the first fine groove.

4. The pneumatic tire as set forth in claim 2, wherein the distance from the bottom of the first fine groove to the second fine groove is 20% to 50% of the first fine groove.
